(19) United States
(12) Patent Application Publication
(10) Pub. No.: US 2025/0207554 A1
(43) Pub. Date: Jun. 26, 2025

(54) Virtual Synchronization Method and System for Energy Storage System and Radial Water Turbine Generator Set

(71) Applicant: Hainan Power Grid Co., Ltd., Haikou (CN)

(72) Inventors: Lihong MA, Haikou (CN); Zhongzhong LI, Haikou (CN); Haisheng WANG, Haikou (CN); Dan QIN, Haikou (CN); Hang ZHOU, Haikou (CN); Changjun ZHANG, Haikou (CN); Donghai LI, Haikou (CN); Linbei FU, Haikou (CN)

(21) Appl. No.: 19/012,056

(22) Filed: Jan. 7, 2025

Related U.S. Application Data
(63) Continuation of application No. PCT/CN2024/104635, filed on Jul. 10, 2024.

(30) Foreign Application Priority Data
Dec. 26, 2023 (CN) 2023118046206

(51) Int. Cl. F03B 15/00; G06F 17/18

(52) U.S. Cl. CPC F03B 15/00; G06F 17/18

(57) ABSTRACT

A virtual synchronization method for an energy storage system and a radial water turbine generator set, relating to the technical field of electrical control strategy design. The method comprises: analyzing the characteristics of the set and designing an energy storage system; obtaining parameters, designing a virtual rotor model, and building a mechanical dynamics equation; designing a virtual synchronization controller and building a closed-loop control system; building a coupled simulation model and optimizing parameters; and implementing a control strategy on a testing platform to carry out and verify. The robustness and adaptability of the control system is greatly enhanced, and the modeling theory is enriched.

### CROSS-REFERENCE TO RELATED APPLICATIONS

The present application claims priority to Chinese Patent Application No. 2023118046206, filed on Dec. 26, 2023, the entire disclosure of which is incorporated herein by reference.

### TECHNICAL FIELD

The present invention relates to the technical field of electrical control strategy design, in particular to a virtual synchronization method and system for an energy storage system and a radial water turbine generator set.

### BACKGROUND

Large power fluctuation of a radial water turbine generator set is its natural characteristic, matched with an energy storage system as an important smoothing means. The core technology of this solution is specific application of the virtual synchronous generator theory in the system. The virtual synchronous generator combines a high-precision mechanical dynamics model with vector closed-loop control, making generator voltage synchronous with a real rotor to provide virtual mechanical inertia and enhance dynamic response of the system. This can effectively suppress power fluctuations compared with direct idle control.

However, the existing virtual synchronous generator technology applied to the energy storage system still has the following problems: i. difficult calibration in unit parameters, resulting in poor control stability; ii. weak adaptability to varying working conditions; and iii. difficult optimization in manual setting of controller parameters. This solution designs adaptive control, predictive control, and a multi-model control module to solve these problems, and obtains a group of globally optimal controller parameters through simulation and optimization, is theoretically complex and difficult to implement. In addition, existing literature seldom consider joint response of the system under abnormal conditions. The reliability of the solution is verified by configuring simulation signals for various fault scenarios, to ensure its practical value. Overall, the high integration of the system, precise model design, and ideal optimization results are the characteristics of this solution, and are expected to further narrow the gap between theory and practice and achieve the economic and efficient utilization of radial water turbine power generation.

### SUMMARY

In view of the problems existing in the application of existing virtual synchronous generator technology in energy storage systems, the present invention is proposed.

Therefore, the problems to be solved by the present invention are poor control stability, weak adaptability to varying working conditions, and difficult optimization in manual setting of controller parameters in the existing virtual synchronous generator technology applied to the energy storage system and the radial water turbine generator set.

To solve the above technical problems, the present invention provides the following technical solutions:

In a first aspect, an embodiment of the present invention provides a virtual synchronization method for an energy storage system and a radial water turbine generator set, including:
analyzing the characteristics of the radial water turbine generator set, and designing an appropriate energy storage system to smooth power fluctuations of the radial water turbine generator set;
obtaining characteristic parameters of the radial water turbine generator set, designing a virtual rotor model according to the characteristic parameters, and building a mechanical dynamics equation;
designing a virtual synchronization controller based on the virtual rotor model, and building a closed-loop control system to control the charge and discharge of the energy storage system;
building a simulation model coupling the energy storage system with the radial water turbine generator set, and optimizing parameters of the controller; and
implementing a proposed virtual synchronization control strategy on an actual testing platform for the radial water turbine generator set, and carrying out experimental verification and result analysis.

As a preferred solution of the virtual synchronization method for the energy storage system and the radial water turbine generator set in the present invention, the designing an appropriate energy storage system includes the following steps:
extracting detection data of past generated power of the radial generator set;
obtaining a probability density function expression using Weibull distribution;
setting constraints on capacity absorption power fluctuations;
substituting the constraints into a Weibull distribution function to compute a minimum capacity of the energy storage system; and
initializing a capacity of the energy storage system to the minimum capacity, and computing the number of charge and discharge cycles that meet smoothing requirements, to obtain a final capacity of the energy storage system;
wherein the probability density function expression is as follows:

$$f ( p ) = \frac{k}{c} * ( \frac{{p}^{k - 1}}{c} * exp [ - {( \frac{p}{c} )}^{k} ]$$

where c presents a scale parameter of the Weibull distribution, k represents a shape parameter of the Weibull distribution, and p represents sample data.

As a preferred solution of the virtual synchronization method for the energy storage system and the radial water turbine generator set in the present invention, the virtual rotor model includes a water turbine model and an electromagnetic torque model;
the water turbine model is shown in the following equation:

$$Tw = k 1 ( a ) QH + k 2 ( H ) * {Q}^{2}$$

where α represents a guide vane opening, and k1(α) and k2(H) represent complex functions of the opening and a head;
considering that the guide vane opening α affects the velocity and flow rate of water entering a turbine:

$$k 1 ( a ) = Ka ( 1 - a ) sin ( π a )$$

where K represents a coefficient related to the head.

As a preferred solution of the virtual synchronization method for the energy storage system and the radial water turbine generator set in the present invention, the electromagnetic torque model is shown in the following equation:

$$Te = {aI}_{f} + {bI}_{f}^{2} \neq c {I}_{f}^{3}$$

where Te represents an electromagnetic torque, denoting a torque output by a motor; I_{f} represents excitation current, which is current in the motor for generating a magnetic field; and a, b, and c represent constant coefficients.

As a preferred solution of the virtual synchronization method for the energy storage system and the radial water turbine generator set in the present invention, the mechanical dynamics equation is shown as follows:

$$J \frac{{d}^{3} θ}{{dt}^{3}} + F \frac{{d}^{2} θ}{{dt}^{2}} + D \frac{d θ}{dt} = Tm - Te - Tw$$

where J represents a moment of inertia, denoting the inertia of the system to rotational motion; θ represents angular displacement, denoting an angular position of the system; t represents time, F represents a damping coefficient of the system, D represents stiffness of the system, Tm represents a torque of a driving system, Te represents the electromagnetic torque, and Tw represents an external torque.

As a preferred solution of the virtual synchronization method for the energy storage system and the radial water turbine generator set in the present invention, the virtual synchronization controller includes an EKF recursive estimation framework, as shown in the following equations:

$$\hat{x} k \vert k - 1 = f ( \hat{x} k - 1 \vert k - 1 , uk , θ \hat{k} - 1 \vert k - 1 )$$

$$Pk \vert k - 1 = AkPk - 1 \vert k - 1 ATk + Q$$

$$Kk = Pk \vert k - 1 HT ( HPK \vert K - 1 HT + R ) - 1$$

$$\hat{x} k \vert k = \hat{x} k \vert k - 1 + Kk ( yk - \hat{y} k \vert k - 1 )$$

$$θ \hat{k} \vert k = θ \hat{k} - 1 \vert k - 1 + θ Correct$$

where \hat{x}k|k−1 represents a predicted state vector at time k, Pk|k−1 represents a predicted state covariance matrix at time k, Ak represents a state transition matrix denoting a derivative of a state equation with respect to a state variable, Pk−1|k−1 represents an updated state covariance matrix at time k−1, Q represents a process noise covariance matrix, Kk represents a Kalman gain matrix at time k, yk represents a measurement output vector at time k, ŷk|k−1 represents measurement prediction based on state prediction at time k, H represents a measurement matrix connecting the state variable with a measurement variable, R represents a measurement noise covariance matrix, \hat{x}k|k represents an estimated updated state vector at time k, θkk represents updated estimation of a parameter vector at time k, and θ Correct represents a vector quantity of parameter estimation correction using a parameter determinacy index.

As a preferred solution of the virtual synchronization method for the energy storage system and the radial water turbine generator set in the present invention, the optimizing parameters of the controller includes the following steps:
building the simulation model coupling the energy storage system with the radial water turbine generator set;
designing abnormalities; and
designing a particle swarm optimization algorithm to compute an optimal group solution;
wherein the particle swarm optimization algorithm comprises the following steps:
randomly generating positions and velocities of N particles;
substituting the position of each particle into the simulation model, running the simulation, and computing set evaluation indicators to obtain a FITNESS value of each particle;
if the FITNESS value of the particle is better than an individual historical optimal value pbest, setting the current value as a new pbest;
if the FITNESS value is better than an optimal value gbest of all the particles, considering that a current global optimal solution is found, and setting the current value as gbest;
updating the velocity and position of each particle to generate new controller parameter solutions using a PSO formula combined with individual logic and group collaboration; and
if a set maximum number of iterations or a set FITNESS error is reached, terminating the computation and outputting a combination of optimal parameters; otherwise, returning to find the FITNESS value of each particle and continuing iterative search.

In a second aspect, an embodiment of the present invention provides a virtual synchronization system for an energy storage system and a radial water turbine generator set, including: an energy storage system design module, configured to select an appropriate energy storage system and determine its capacity according to generated power fluctuation characteristics of the radial water turbine generator set;
a virtual rotor model building module, configured to obtain parameters of the radial water turbine generator set, build an accurate water turbine model and high-order electrical model, and design a virtual rotor model;
a virtual synchronization controller design module, configured to build a closed-loop control system to control the charge and discharge of the energy storage system and improve control performance by adaptive PI parameter adjustment and speed prediction;
a joint simulation modeling and optimization module, configured to build a coupled simulation platform, configure input signals under various working conditions, carry out multi-scenario joint simulation, and optimize controller parameters using a particle swarm optimization algorithm; and
an experimental verification module, configured to implement a virtual synchronization control strategy on an actual testing platform, carry out no-load test, load test and abnormal working condition verification, and analyze results.

In a third aspect, an embodiment of the present invention provides a computer device including a memory and a processor, the memory storing a computer program, where the processor executes the computer program to implement any step of the virtual synchronization method for the energy storage system and the radial water turbine generator set as described above.

In a fourth aspect, an embodiment of the present invention provides a computer-readable storage medium storing a computer program, where the computer program, when executed by a processor, implements any step of the virtual synchronization method for the energy storage system and the radial water turbine generator set as described above.

The beneficial effects of the present invention are as follows: the fluctuations of output power of the radial water turbine generator set are effectively smoothed. By reasonably configuring the energy storage system and coordinating the charge and discharge control on the unit and energy storage, grid-connected power can be kept stable, frequent start/stop and grid-off are avoided, power generation efficiency is improved, and the dynamic support capability of a grid side is enhanced. The application of the virtual synchronous generator theory provides virtual mechanical inertia for the power grid, which is conducive to suppressing abnormal fluctuations in voltage and frequency, improves system stability and power supply reliability, and achieves real-time on-line calibration of unit parameters and adaptive optimization adjustment of the controller. By independently developed prediction and multi-model control strategy modules, the robustness of the control system is greatly enhanced, the system adapts to varying working conditions, and the modeling and analysis theory of the radial water turbine generator set and energy storage coupling system is enriched. By joint simulation under various working conditions, a large amount of valuable state response data is obtained to lay a foundation for further improving the level of system coordination and control.

### BRIEF DESCRIPTION OF DRAWINGS

To describe the technical solutions in embodiments of the present invention more clearly, the following briefly describes the accompanying drawings required for describing the embodiments. Apparently, the accompanying drawings in the following descriptions show merely some embodiments of the present invention, and those of ordinary skill in the art may derive other drawings from these accompanying drawings without creative efforts. In the figures:

FIG. 1 is a flowchart of a virtual synchronization method for an energy storage system and a radial water turbine generator set.

FIG. 2 is a flowchart of optimizing controller parameters in the virtual synchronization method for the energy storage system and the radial water turbine generator set.

### DETAILED DESCRIPTION OF THE EMBODIMENTS

To make the above objectives, features and advantages of the present invention more obvious and understandable, specific implementations of the present invention will be described in detail below with reference to the accompanying drawings. Apparently, the described embodiments are merely some of the embodiments of the present invention, not all of them. Based on the embodiments in the present invention, all other embodiments obtained by those of ordinary skill in the art without creative efforts shall fall within the scope of protection of the present invention.

Many specific details are set forth in the following description to facilitate a full understanding of the present invention, but the present invention can also be implemented in other ways different from those described here, and those skilled in the art can do similar promotions without departing from the connotation of the present invention. Therefore, the present invention is not limited by the specific embodiments disclosed below.

Secondly, the term “one embodiment” or “embodiments” referred to here refers to specific features, structures, or features that may be included in at least one implementation of the present invention. The term “in one embodiment” appearing in different places of this specification neither necessarily refers to the same embodiment, nor is a separate or selective embodiment exclusive with other embodiments.

The present invention is described in detail with reference to the schematic diagrams. When the embodiments of the present invention are elaborated, for the convenience of explanation, the cross-sectional views representing device structures are not partially enlarged according to general scales, and the schematic diagrams show merely examples and should not limit the scope of protection of the present invention. Moreover, three-dimensional spatial dimensions including length, width, and depth should be included in actual fabrication.

Meanwhile, in the description of the present invention, it should be noted that the orientations or position relations indicated by the terms “upper, lower, inner, and outer” are based on the orientations or position relations shown in the accompanying drawings, are intended to facilitate the description of the present invention and simplify the description only, rather than indicating or implying that a device or element referred to must have a particular orientation or be constructed and operated in a particular orientation, and therefore, cannot be interpreted as limiting the present invention. Furthermore, the term “first, second, or third” is merely for the sake of description, and cannot be understood as indicating or implying the relative importance.

Unless otherwise specified and limited in the present invention, the term “mounted, connected, and connection” should be understood in a broad sense. For example, the “connection” may be fixed connection, detachable connection, integral connection, mechanical connection, electrical connection, direct connection, indirect connection by a medium, or internal communication between two elements. Those of ordinary skill in the art can understand the specific meanings of the above terms in the present invention according to specific circumstances.

### Embodiment 1

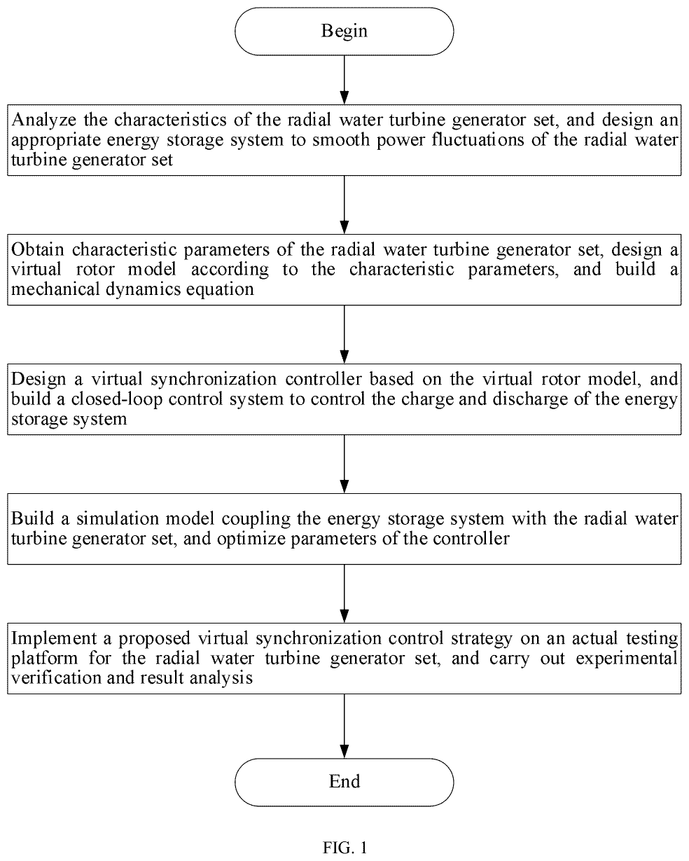

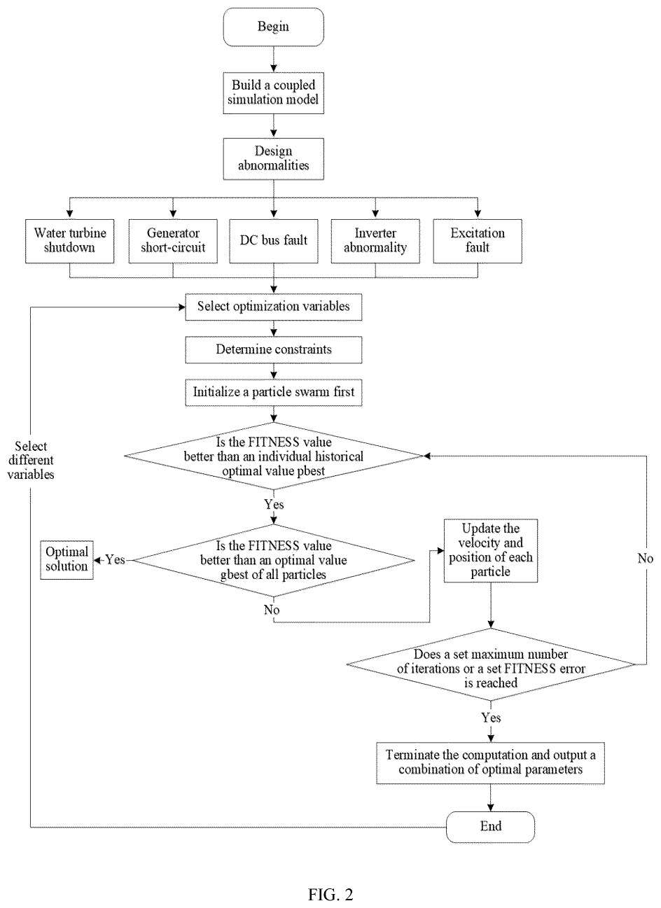

FIG. 1 and FIG. 2 show a first embodiment of the present invention. This embodiment provides a virtual synchronization method for an energy storage system and a radial water turbine generator set, including:

S1: Analyze the characteristics of the radial water turbine generator set, and design an appropriate energy storage system to smooth power fluctuations of the radial water turbine generator set;

A large capacity battery is selected by analyzing the current power generation characteristics of the radial water turbine generator set and considering that the energy storage system needs to have the function of filling in power generation fluctuations and a radial water turbine has a large power generation capacity. Considering system response rate requirements and fast power fluctuations of the radial water turbine, the energy storage system composed of the battery needs to have a high response speed. Based on the above analysis and considerations, a combination of a liquid flow battery and a lithium battery is used to form the energy storage system to match the current application situation.

Operating logs of the radial water turbine generator set over a period of time past are looked up, monitoring data of generated power are extracted, and the extracted data are pre-processed by de-noising, interpolation, and the like to obtain continuous time series data of generated power: {P(t1), P(t2), . . . , P(tn)}.

Samples {P1, P2, . . . , Pn} are extracted from the time series data of generated power, and sample data are sorted to obtain sequential statistical samples {P(1), P(2), . . . , P(n)}. The sequential samples are mapped onto a uniform distribution to obtain converted samples {F(1), F(2), . . . , F(n)}. F(i)=(i−0.5)/n, logarithms of the converted samples are taken, and linear regression is performed to determine k and c: ln[−ln(1−F(i))]=kln(P(i))−kln(c).

The pre-processed time series data of generated power are imported as samples into a probability distribution fitting toolkit, and an expression of a probability density function is obtained using Weibull distribution:

$$f ( p ) = \frac{k}{c} * ( \frac{{p}^{k - 1}}{c} * exp [ - {( \frac{p}{c} )}^{k} ]$$

Here, c presents a scale parameter of the Weibull distribution, and k represents a shape parameter of the Weibull distribution.

Further, an average value u and a standard deviation σ of the samples are computed from the pre-processed time series data of generated power, a ratio of the standard deviation σ to the average value μ is a coefficient of variation Cv, and the computed coefficient of variation Cv is compared with a typical coefficient of variation of the water turbine power generator set to determine the power stability of the set.

Further, constraints on capacity absorption power fluctuation are set, and integral computation is carried out according to the probability density function of the Weibull distribution. When the capacity of the energy storage system is more than 2.6 σ of a power fluctuation, over 99% of the power fluctuation can be absorbed. The capacity of the energy storage system is set to be greater than 3*σ.

Furthermore, a power fluctuation range that meets given reliability requirements is computed, for example, if the power fluctuation is required to be less than 20% of the average power, the reliability is 99.7%.

The minimum charge capacity is: average power*20%*(1−3/n)

N represents a sample size of the time series data, and the corresponding value of 3/n is within a three sigma range with a given reliability of 99.7%. So constraints are set as follows:

The minimum charge capacity of the energy storage system is greater than the average power*20%*(1−3/n).

Then the constraints are substituted into the Weibull distribution function, and a minimum capacity Cmin of the energy storage system that satisfies the constraint is computed by integration. The capacity C of the energy storage system is initialized to the minimum capacity Cmin.

Further, rated power Pe and maximum power Pcmax of the radial water turbine generator set are obtained, maximum allowable charge power PC_{battery_max} of the energy storage system is obtained according to its characteristics, and a charge power range PC_{grid_min} to PC_{grid_max} is obtained according to the limitation of a power grid on the rate of power change of the generator set. PCₘᵢₙ=max(PC_{grid_min}, PC_{battery_min}) and PCₘₐₓ=min (PC_{grid_max}, PC_{battery_max}, PCₘₐₓ) are set. So the charge power range Pc is: PCₘᵢₙ≤Pc≤PCₘₐₓ, an intermediate value is selected as the optimal Pc value, and the same applies to discharge power Pd.

Further, a program is written, and the number of charge and discharge cycles that meet power smoothing requirements is computed under the set capacity of the energy storage system. The set capacity C, charge power Pc, and discharge power Pd of the energy storage system are input, the power time series data P (t) of the generator set are read, a cycle counter is initialized to count=0, and the power time series data are traversed: if P(t)>C, the counter adds 1; if P(t)<0, the counter adds 1, the charge capacity of the energy storage system is updated: SOC=SOC+Pc*Δt (charge); SOC=SOC−Pd*Δt (discharge).

At the end of the cycles, the count is output as a total number of charge and discharge cycles. The capacity C of the energy storage system is changed, and the above steps are repeated to obtain numbers of charge and discharge cycles under different capacities. A relationship curve between different capacities and the numbers of charge and discharge cycles is drawn, the capacity with the least number of charge and discharge cycles is selected as an optimal value according to the characteristics of the curve, and simulation verification and site test are carried out on the capacity. If the capacity passes through the verification, the capacity is determined as a final capacity.

S2: Obtain characteristic parameters of the radial water turbine generator set, design a virtual rotor model according to the characteristic parameters, and build a mechanical dynamics equation.

Technical data of the radial water turbine generator set are looked up, and key parameters are recorded, including rated power Pn, rated speed Nn, rated torque In, flow rate Q and head H during the operation of a water turbine, and rotational inertias J of the water turbine and a generator.

Further, no-load test is carried out to record no-load voltage U0 and no-load current I0, short-circuit test is carried out to record short-circuit current Ik and short-circuit resistance Rk, and then load test is carried out to obtain power P, speed n, current I, voltage U, and power factor cos ϕ at each load point.

Furthermore, an accurate water turbine model is built according to the obtained relevant parameters of the radial water turbine generator set and in consideration with the effects of a guide vane opening and a head, where a torque expression of the water turbine is as follows:

$$Tw = k 1 ( a ) QH + k 2 ( H ) * {Q}^{2}$$

Here, α represents the guide vane opening, and k1(α) and k2(H) represent complex functions of the opening and the head.

Considering that the guide vane opening a affects the velocity and flow rate of water entering a turbine, the following can be obtained according to the fluid dynamics theory:

$$k 1 ( a ) = Ka ( 1 - a ) sin ( π a )$$

Here, K represents a coefficient related to the head, and the function reflects the non-linear effect of the opening α. When α approaches 0, k1 approximates 0; when a is about 0.5, k1 reaches its maximum; when α approaches 1, k1 tends towards 0 again.

On the other hand, the head H determines the kinetic energy of water. According to the theory of the water turbine, the relationship between torque and head is approximately a square relationship: k2(H)=K′*H\hat{ }2.

Here, K′ represents a coefficient related to the guide vane opening, which reflects a quadratic relationship of the head. The higher the head, the greater the kinetic energy of the water, and the greater the torque generated by the water turbine.

Further, a high-order electrical model is built, and an electromagnetic torque equation is a third-order expression:

$$Te = {aI}_{f} + {bI}_{f}^{2} + {cI}_{f}^{3}$$

Here, Te represents an electromagnetic torque, denoting a torque output by a motor; I_{f} represents excitation current, which is current in the motor for generating a magnetic field; and a, b, and c represent constant coefficients.

Further, a virtual rotor model is designed according to characteristic parameters, and a mechanical dynamics equation is built:

$$J \frac{{d}^{3} θ}{{dt}^{3}} + F \frac{{d}^{2} θ}{{dt}^{2}} + D \frac{d θ}{dt} = Tm - Te - Tw$$

Here, J represents a moment of inertia, denoting the inertia of the system to rotational motion; θ represents angular displacement, denoting an angular position of the system; t represents time, F represents a damping coefficient of the system, D represents stiffness of the system, Tm represents a torque of a driving system, Te represents the electromagnetic torque, and Tw represents an external torque.

S3: Design a virtual synchronization controller based on the virtual rotor model, and build a closed-loop control system to control the charge and discharge of the energy storage system.

A fuzzy logic-based PI parameter on-line adaptive adjustment module is designed to monitor a speed deviation and a deviation change rate in real time, and KP and KI are automatically adjusted for different working states to achieve optimal dynamic response of the closed-loop control system.

Further, a speed prediction model module is added to a front end of the PI controller to predict a speed trend for a period of time in the future according to historical data and a state estimation algorithm. A combination of a prior predicted value and an actual sampled speed data serves as an input signal of the PI controller to improve the adaptability of the controller to random disturbances and emergencies.

Further, a plurality of linearized virtual rotor models are built, and an automatic controller switching module based on the plurality of models and the model identifiability theory is designed. When a significant change in the working state of the system is detected, the controller is quickly switched to a most appropriate one of candidate controllers to ensure closed-loop stability and fast tracking.

Virtual rotor parameters are estimated using an EKF recursive estimation framework and coordinated with the PI controller, including the steps of state prediction, covariance prediction, Kalman gain computation, state update, and the like. The virtual rotor parameters are calibrated on line;

EKF prediction and update equations are shown as follows:

$$\hat{x} k \vert k - 1 = f ( \hat{x} k - 1 \vert k - 1 , uk , θ \hat{k} - 1 \vert k - 1 )$$

$$Pk \vert k - 1 = AkPk - 1 \vert k - 1 ATk + Q$$

$$Kk = Pk \vert k - 1 HT ( HPK \vert K - 1 HT + R ) - 1$$

$$\hat{x} k \vert k = \hat{x} k \vert k - 1 + Kk ( yk - \hat{y} k \vert k - 1 )$$

$$θ \hat{k} \vert k = θ \hat{k} - 1 \vert k - 1 + θ Correct$$

Here, \hat{x}k|k−1 represents a predicted state vector at time k, Pk|k−1 represents a predicted state covariance matrix at time k, Ak represents a state transition matrix denoting a derivative of a state equation with respect to a state variable, Pk−1|k−1 represents an updated state covariance matrix at time k−1, Q represents a process noise covariance matrix, Kk represents a Kalman gain matrix at time k, yk represents a measurement output vector at time k, ŷk|k−1 represents measurement prediction based on state prediction at time k, H represents a measurement matrix connecting the state variable with a measurement variable, R represents a measurement noise covariance matrix, \hat{x}k|k represents an estimated updated state vector at time k, θk|k represents updated estimation of a parameter vector at time k, and θ Correct represents a vector quantity of parameter estimation correction using a parameter determinacy index.

Further, an empirical setting model between each virtual rotor parameter and the PI controller parameters (KP, KI) is built:

$$Kp = fkp ( J ) ; Ki = fki ( B )$$

A parameter determinacy index of EKF estimation, is monitored and combined with the setting model to automatically correct the PI controller parameters, so as to achieve collaborative optimization of controller and rotor parameter calibration and improve robustness.

S4: Build a simulation model coupling the energy storage system with the radial water turbine generator set, and optimize parameters of the controller.

A hydraulic characteristic model of the water turbine is built according to actual parameters of the water turbine; generator and excitation system models are built; and the models are coordinated with head and flow data to form a simulation model. A charge and discharge characteristic model of the energy storage system including a battery/super-capacitor/flywheel is built according to the battery type and corresponding capacity parameters of the energy storage system determined in S1.

The radial generator set model is connected with the charge and discharge control model of the energy storage system in Simulink to form a coupled simulation platform, controller parameters are set, and a pre-designed virtual synchronization closed-loop control system model including speed, voltage, and power PI controller is added to the joint model.

Simulation analysis indicators such as transient stability and harmonic distortion are set to further determine performance evaluation indicators of the controller, including bandwidth, static adjustment accuracy, etc.

Further, the main input variables of the radial water turbine are head and flow. The two variables change according to actual river conditions. A head and flow curve under different flood discharge/pumping conditions is configured, where the curve needs to include some disturbance. Abnormalities such as shutdown of the water turbine and transient disconnection of loads are designed.

The water turbine is shut down, and the input head and flow are directly reduced to 0 to simulate the shutdown of the water turbine. A curve of sequentially decreasing head and flow is built to simulate a more realistic shutdown process. For transient disconnection of the loads, a circuit breaker module is added to the joint simulation model and disconnected at the load end through control signals. Different moments of disconnection are set to form a transient process. For short-circuiting of the generator, a controllable circuit breaker is also added to the joint simulation model, and the generator end is connected to a low impedance load, to form different degrees of short-circuit faults. Multiple times of short-circuiting are set by the control signals. For DC bus faults, one battery unit or super-capacitor unit is randomly selected in the energy storage system model, and the fault state of the DC bus is simulated by adding an open-circuit or short-circuit module. For inverter abnormalities, the duty cycle and frequency of PWM signals are changed to simulate overcurrent and overvoltage faults of IGBT switching elements. The inverter is subjected to protection dropout or performance degradation. For excitation faults, an abnormality module can be added to an excitation power model, so that an excitation system loses power or a filter capacitor is short-circuited, thereby forming excitation faults in the model.

Further, input signals such as head and flow are enabled to automatically load and switch according to the set curve. A random disturbance term is added. The joint simulation model is activated multiple times, the input signals under different working conditions are loaded one by one, and response curves of various variables in the system are observed. Key parameter curves of the system, such as speed and power of the generator, torque, head and flow of the water turbine, and charge and discharge statuses of the energy storage system, are recorded. Output data are processed using Matlab software to obtain dynamic response characteristics under different working conditions, so as to provide a basis for later optimization of the controller parameters.

Further, the main objective of optimizing the controller is to improve the dynamic response speed and stability of the system by setting indicators such as maximum overshoot and adjustment time. Optimized variables, namely, the parameters of the controller, mainly including proportional and integral parameters of the PI controller, are selected, and constraints such as limitation on the amplitude of control signals and adjustment on lower limit requirement of time are determined. These conditions need to be satisfied simultaneously.

Furthermore, a particle swarm optimization algorithm is designed, where a particle swarm is first initialized to randomly generate positions (a combination of controller parameters) and velocities of N particles; the position of each particle is substituted into the simulation model, the simulation is run, and set evaluation indicators are computed to obtain a FITNESS value of each particle. If the FITNESS value of the particle is better than an individual historical optimal value pbest, the current value is set as a new pbest. If the FITNESS value is better than an optimal value gbest of all the particles, it is considered that a current global optimal solution is found, and the current value is set as gbest. The velocity and position of each particle are updated to generate new controller parameter solutions using a PSO formula combined with individual logic and group collaboration. If a set maximum number of iterations or a set FITNESS error is reached, the computation is terminated and a combination of optimal parameters is output. Otherwise, step 2 is carried out again to continue iterative search.

After a group of optimal parameters is computed according to the particle swarm optimization algorithm, the parameters are solved according to multiple situations and optimized under different disturbance inputs and different working conditions to obtain a group of frequency domain stable parameters.

Head and flow signals under dry season, wet season, and moderate water flow conditions are configured separately for different head and flow conditions, and the parameters of the controller are repeatedly optimized to obtain optimal parameter solutions under the 3 working conditions.

Under different load disturbances, step load changes and linearly increasing/decreasing loads are added on the basis of various working conditions for parameter optimization. The load parameters including harmonic disturbances of different frequencies and amplitudes are also considered.

Different abnormalities are combined, where the abnormalities such as shutdown of the water turbine and load disconnection are additionally combined on the basis of the signals of various working conditions, for parameter optimization to obtain a more comprehensive combination of optimal parameters.

For changes in the capacity of the energy storage system, system models are respectively built for small, medium, and large energy storage battery capacities, and parameters under different energy storage capacities are compared on the basis of signal optimization for various working conditions to select optimal matching parameters.

For changes in parameter dispersion of the generator, considering random disturbances of percentages of stator resistance and rotor reactance parameters of the generator, the impact on the frequency domain performance of the controller parameters is observed.

Finally, random noise input is added, the time-domain waveform of the system is observed, and various evaluation indicators are analyzed to prove that the optimization meets set target requirements.

S5: Implement a proposed virtual synchronization control strategy on an actual testing platform for the radial water turbine generator set, and carry out experimental verification and result analysis.

Hardware construction of the control system: an industrial computer, a data acquisition card, and an information collection and distribution module are installed on the testing platform, electrical connections are completed, and the water turbine generator set and the energy storage device are assembled, to ensure normal operation of the hardware system. Development of software function code: the designed virtual synchronization closed-loop control model is converted into unit control execution code by means of tools such as Simulink and PLCOpen, and the code is downloaded to the industrial computer. Parameter setting and debugging: constant load conditions of the water turbine are set; the parameters of the controller, including a PI coefficient, virtual rotor inertia, etc. are configured; and the logic of the control code is carefully debugged.

Further, no-load test is carried out, the water turbine is started for no-load operation, the building of the magnetic field of the generator and the acceleration process of the rotor are verified, that the controller can accurately track the set speed-voltage curve is observed, and then grid connection operation is carried out. Loads are tested, where the loads of different sizes are connected to the generator end to test the tracking speed of the control system for load transients and the flow stability of the water turbine, and the control performance is determined by waveform analysis.

Finally, abnormal working conditions including artificially constructed intermittent head, load disconnection, and the like are verified, the reset process of the control system is recorded, the dynamic response curves of various state variables are analyzed, and the stability and dynamic characteristics of the system are checked.

Further, this embodiment provides a virtual synchronization system for an energy storage system and a radial water turbine generator set, including:
an energy storage system design module, configured to select an appropriate energy storage system and determine its capacity according to generated power fluctuation characteristics of the radial water turbine generator set;
a virtual rotor model building module, configured to obtain parameters of the radial water turbine generator set, build an accurate water turbine model and high-order electrical model, and design a virtual rotor model;
a virtual synchronization controller design module, configured to build a closed-loop control system to control the charge and discharge of the energy storage system and improve control performance by adaptive PI parameter adjustment and speed prediction;
a joint simulation modeling and optimization module, configured to build a coupled simulation platform, configure input signals under various working conditions, carry out multi-scenario joint simulation, and optimize controller parameters using a particle swarm optimization algorithm; and
an experimental verification module, configured to implement a virtual synchronization control strategy on an actual testing platform, carry out no-load test, load test and abnormal working condition verification, and analyze results.

This embodiment further provides a computer device applicable to the virtual synchronization method for the energy storage system and the radial water turbine generator set, including a memory and a processor, where the memory is configured to store computer executable instructions, and the processor is configured to execute the computer executable instructions to implementing the virtual synchronization method for the energy storage system and the radial water turbine generator set provided in the above embodiments.

The computer device may be a terminal. The computer device includes a processor, a memory, a communication interface, a display, and an input apparatus connected by a system bus. The processor of the computer device is configured to provide computing and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The communication interface of the computer device is configured to communicate with an external terminal in a wired or wireless manner, where the wireless manner may be implemented by WIFI, an operator network, NFC (Near Field Communication) or other technologies. The display of the computer device may be a liquid crystal display or an electronic ink display. The input apparatus of the computer device may be a touch layer covering the display, or may be a button, a trackball, or a touchpad disposed on a housing of the computer device, or may be an external keyboard, an external touchpad, a mouse, or the like.

This embodiment further provides a storage medium, storing a computer program that, when executed by a processor, implements the virtual synchronization method for the energy storage system and the radial water turbine generator set provided in the above embodiments.

The storage medium provided in this embodiment belongs to the same inventive concept as the data storage method provided in the above embodiments. Technical details not fully described in this embodiment can be found in the above embodiments, and this embodiment has the same beneficial effects as the above embodiments.

### Embodiment 2

FIG. 2 shows a second embodiment of the present invention. This embodiment provides a virtual synchronization method for an energy storage system and a radial water turbine generator set. In order to verify the beneficial effects of the present invention, scientific verification was carried out by economic benefit computations and simulation experiments.

The application scenario of this implementation scheme is a 100 MW radial water turbine power station in a segment of the Yangtze River. The power station has a large installed capacity, and its output power varies significantly with seasonal fluctuations of water. To smooth power fluctuations and improve the acceptance capacity of a power grid, this scheme proposed to configure a large-capacity energy storage system at the power station to form coordinated control with a unit and jointly output stable power to the grid side.

In this scheme, historical statistical power generation time series data were first analyzed. A probability distribution pattern of power fluctuations was determined by fitting using Weibull distribution. According to given power fluctuation constraints, it was determined that the required minimum capacity of the energy storage system was 60 MWh. To balance response speed, this scheme used a combination of an 80 MWh liquid flow battery and a 40 MWh lithium battery. Details are shown in Table 1.

TABLE 1
Battery combination form

| Parameter | Value |
|---|---|
| Rated power of the radial flow | 100 MW |
| generator set | |
| Weibull fitting parameters (c, k) | (5 MW, 1.8) |
| Power fluctuation limit | 20% of the average power |
| Determined minimum energy | 60 MWh |
| storage capacity | |
| Actual energy storage system | 80 MWh liquid flow battery + |
| | 40 MWh lithium battery |

After the rated parameters of the generator set were obtained, an accurate physical model and high-order electrical model of a water turbine were built. A virtual rotor system was designed, and corresponding mechanical dynamics equations were built to match electrical and mechanical characteristics. On this basis, a virtual synchronization closed-loop control system was designed and developed to adjust the output of an inverter in real time and achieve coordinated optimization control on the charge and discharge process of the energy storage system. Specific parameters of a virtual rotor model are shown in Table 2.

TABLE 2
Parameters of the virtual rotor model

| Parameter | Value | |
|---|---|---|
| Rated power of a generator Pn | 100 | MW |
| Rated speed Nn | 128 | rpm |
| Rated torque Tn | 7.2 | MN · m |
| Water turbine flow Q | 650 | m³/s |
| Head H | 24 | m |
| Moment of inertia J | 28000 | kg · m |

In the testing, the water turbine flow was set to 500 m³/s and the head was set to 20 m. In this case, the shaft power was about 82 MW, and the load power output to the grid was 58 MW. For different scenarios, a group of controller parameters were obtained and optimized by multiple simulation computations, such as KP=2.1 and KI=0.35 in the dry season. The closed-loop control system includes a speed prediction module, a fuzzy adaptive PI module, a multi-model switching module, and a Kalman filter rotor parameter collaborative optimization module. After simulation tests and particle swarm optimization computations under various typical working conditions, a globally optimal combination of controller parameters was obtained. Finally verification was carried out on an actual testing platform of the power station. The results showed that this design scheme can effectively suppress the power fluctuations, enhance the floating response and fault self-recovery capability of the system, and achieve the design objective. Details are as shown in Table 3.

TABLE 3
Parameter optimization table

| Working condition | Optimized KP | Optimized KI |
|---|---|---|
| Dry season | 2.1 | 0.35 |
| Wet season | 1.8 | 0.25 |
| Load change | 2.3 | 0.4 |

This experiment selected a medium head and flow condition under a typical load condition. The shaft power of the water turbine was set to about 80% of the rated power and the flow was set to 75% of the rated flow to ensure an efficient and stable working state of the water turbine. An optimal power point corresponding to the shaft end of the water turbine under the head and flow condition was determined by off-line computation. A load having 80% of the optimal power was connected to the generator, to ensure a stable excess power margin for verifying the power tracking capability of the controller. Before the experimental verification, the energy storage system was pre-charged with an external direct current power source, and the initial SOC of the energy storage system was set to 50% to obtain sufficient space for subsequent charge and discharge adjustment and prevent the influence of high and low limit constraints in the testing process. Voltage and current data at the generator were measured using a high-precision power analyzer. Meanwhile, information such as shaft speed of the water turbine and SOC, current, and voltage of the energy storage system was stored. All signal sampling frequencies were not less than 1 kHz to fully record the dynamic evolution process. Finally, it was derived by verification that this scheme complied with the virtual synchronization strategy specified earlier.

It should be noted that the above embodiments are merely used for illustrating, but not limiting, the technical solutions of the present invention. Although the present invention is described in detail with reference to preferred embodiments, those of ordinary skill in the art should understand that the technical solutions of the present invention can be modified or equivalently substituted without departing from the spirit and scope of the technical solutions of the present invention, and all the modifications and equivalent substitutions should fall within the scope of the claims of the present invention.

What is claimed is:

1. A virtual synchronization method for an energy storage system and a radial water turbine generator set, comprising:
analyzing the characteristics of the radial water turbine generator set, and designing an appropriate energy storage system to smooth power fluctuations of the radial water turbine generator set;
obtaining characteristic parameters of the radial water turbine generator set, designing a virtual rotor model according to the characteristic parameters, and building a mechanical dynamics equation;
designing a virtual synchronization controller based on the virtual rotor model, and building a closed-loop control system to control the charge and discharge of the energy storage system;
building a simulation model coupling the energy storage system with the radial water turbine generator set, and optimizing parameters of the controller; and
implementing a proposed virtual synchronization control strategy on an actual testing platform for the radial water turbine generator set, and carrying out experimental verification and result analysis.

2. The virtual synchronization method for the energy storage system and the radial water turbine generator set according to claim 1, wherein the designing an appropriate energy storage system comprises the following steps:
extracting detection data of past generated power of the radial generator set;
obtaining a probability density function expression using Weibull distribution;
setting constraints on capacity absorption power fluctuations;
substituting the constraints into a Weibull distribution function to compute a minimum capacity of the energy storage system; and
initializing a capacity of the energy storage system to the minimum capacity, and computing the number of charge and discharge cycles that meet smoothing requirements, to obtain a final capacity of the energy storage system;
wherein the probability density function expression is as follows:
$$f ( p ) = \frac{k}{c} * ( \frac{{p}^{k - 1}}{c} * exp [ - {( \frac{p}{c} )}^{k} ]$$
wherein c presents a scale parameter of the Weibull distribution, k represents a shape parameter of the Weibull distribution, and p represents sample data.

3. The virtual synchronization method for the energy storage system and the radial water turbine generator set according to claim 2, wherein the virtual rotor model comprises a water turbine model and an electromagnetic torque model;
the water turbine model is shown in the following equation:
$$Tw = k 1 ( a ) QH + k 2 ( H ) * {Q}^{2}$$
wherein α represents a guide vane opening, and k1(α) and k2(H) represent complex functions of the opening and a head;
considering that the guide vane opening α affects the velocity and flow rate of water entering a turbine:
$$k 1 ( a ) = Ka ( 1 - a ) sin ( π a )$$
wherein K represents a coefficient related to the head.

4. The virtual synchronization method for the energy storage system and the radial water turbine generator set according to claim 3, wherein the electromagnetic torque model is shown in the following equation:
$$Te = {aI}_{f} + {bI}_{f}^{2} + {cI}_{f}^{3}$$
wherein Te represents an electromagnetic torque, denoting a torque output by a motor; I_{f} represents excitation current, which is current in the motor for generating a magnetic field; and a, b, and c represent constant coefficients.

5. The virtual synchronization method for the energy storage system and the radial water turbine generator set according to claim 4, wherein the mechanical dynamics equation is shown as follows:
$$J \frac{{d}^{3} θ}{{dt}^{3}} + F \frac{{d}^{2} θ}{{dt}^{2}} + D \frac{d θ}{dt} = Tm - Te - Tw$$
wherein J represents a moment of inertia, denoting the inertia of the system to rotational motion; θ represents angular displacement, denoting an angular position of the system; t represents time, F represents a damping coefficient of the system, D represents stiffness of the system, Tm represents a torque of a driving system, Te represents the electromagnetic torque, and Tw represents an external torque.

6. The virtual synchronization method for the energy storage system and the radial water turbine generator set according to claim 5, wherein the virtual synchronization controller comprises an EKF recursive estimation framework, as shown in the following equations:
$$\hat{x} k \vert k - 1 = f ( \hat{x} k - 1 \vert k - 1 , uk , θ \hat{k} - 1 \vert k - 1 )$$
$$Pk \vert k - 1 = AkPk - 1 \vert k - 1 ATk + Q$$
$$Kk = Pk \vert k - 1 HT ( HPK \vert K - 1 HT + R ) - 1$$
$$\hat{x} k \vert k = \hat{x} k \vert k - 1 + Kk ( yk - \hat{y} k \vert k - 1 )$$
$$θ \hat{k} \vert k = θ \hat{k} - 1 \vert k - 1 + θ Correct$$
wherein \hat{x}k|k−1 represents a predicted state vector at time k, Pk|k−1 represents a predicted state covariance matrix at time k, Ak represents a state transition matrix denoting a derivative of a state equation with respect to a state variable, Pk−1|k−1 represents an updated state covariance matrix at time k−1, Q represents a process noise covariance matrix, Kk represents a Kalman gain matrix at time k, yk represents a measurement output vector at time k, ŷk|k−1 represents measurement prediction based on state prediction at time k, H represents a measurement matrix connecting the state variable with a measurement variable, R represents a measurement noise covariance matrix, \hat{x}k|k represents an estimated updated state vector at time k, θk|k represents updated estimation of a parameter vector at time k, and θ Correct represents a vector quantity of parameter estimation correction using a parameter determinacy index.

7. The virtual synchronization method for the energy storage system and the radial water turbine generator set according to claim 6, wherein the optimizing parameters of the controller comprises the following steps:
building the simulation model coupling the energy storage system with the radial water turbine generator set;
designing abnormalities; and
designing a particle swarm optimization algorithm to compute an optimal group solution;
wherein the particle swarm optimization algorithm comprises the following steps:
randomly generating positions and velocities of N particles;
substituting the position of each particle into the simulation model, running the simulation, and computing set evaluation indicators to obtain a FITNESS value of each particle;
if the FITNESS value of the particle is better than an individual historical optimal value pbest, setting the current value as a new pbest;
if the FITNESS value is better than an optimal value gbest of all the particles, considering that a current global optimal solution is found, and setting the current value as gbest;
updating the velocity and position of each particle to generate new controller parameter solutions using a PSO formula combined with individual logic and group collaboration; and
if a set maximum number of iterations or a set FITNESS error is reached, terminating the computation and outputting a combination of optimal parameters; otherwise, returning to find the FITNESS value of each particle and continuing iterative search.

8. A virtual synchronization system for an energy storage system and a radial water turbine generator set, based on the virtual synchronization method for the energy storage system and the radial water turbine generator set according to claim 1, comprising:
an energy storage system design module, configured to select an appropriate energy storage system and determine its capacity according to generated power fluctuation characteristics of the radial water turbine generator set;
a virtual rotor model building module, configured to obtain parameters of the radial water turbine generator set, build an accurate water turbine model and high-order electrical model, and design a virtual rotor model;
a virtual synchronization controller design module, configured to build a closed-loop control system to control the charge and discharge of the energy storage system and improve control performance by adaptive PI parameter adjustment and speed prediction;
a joint simulation modeling and optimization module, configured to build a coupled simulation platform, configure input signals under various working conditions, carry out multi-scenario joint simulation, and optimize controller parameters using a particle swarm optimization algorithm; and
an experimental verification module, configured to implement a virtual synchronization control strategy on an actual testing platform, carry out no-load test, load test and abnormal working condition verification, and analyze results.

9. A computer device comprising a memory and a processor, the memory storing a computer program, wherein the processor executes the computer program to implement the steps of the virtual synchronization method for the energy storage system and the radial water turbine generator set according to claim 1.

10. A computer-readable storage medium storing a computer program, wherein the computer program, when executed by a processor, implements the steps of the virtual synchronization method for the energy storage system and the radial water turbine generator set according to claim 1.
